(19) United States
(12) Patent Application Publication
(10) Pub. No.: US 2021/0132227 A1
(43) Pub. Date: May 6, 2021

(54) VEHICLE HEIGHT CLEARANCE SENSOR SYSTEM

(71) Applicant: Umm Al-Qura University, Makkah (SA)

(72) Inventor: Khalid Aboalshamat, Makkah (SA)

(73) Assignee: Umm Al-Qura University, Makkah (SA)

(21) Appl. No.: 16/675,152

(22) Filed: Nov. 5, 2019

(51) Int. Cl. G01S 17/87; G07C 9/00

(52) U.S. Cl. CPC G01S 17/87; B60W 2050/143; B60W 2420/40; G07C 9/00

(57) ABSTRACT

The present disclosure relates to a vehicle height clearance system, comprising: an infrared emission bar; a photo-sensor bar; an alarming light bar and an electronic sign, wherein the system help in indicating if a vehicle is above a permissible height and help a driver to decide whether to enter or not to enter the vehicle into a garage or a parking lot entrance gate. The system generates two infrared lines, wherein crossing of one infrared line, indicates that the vehicle in within the permissible height and crossing of both the infrared lines indicate that the vehicle is above the permissible height and thus should not or cannot enter the garage or a parking lot entrance gate.

### FIELD OF TECHNOLOGY

This disclosure relates generally to a vehicle height clearance sensor system and more particularly to allow a garage or parking lot to manage vehicles with above the permissible height.

### BACKGROUND

Garages or parking lots which have a vehicle height restrictions, usually have a way of dealing with such vehicles by posting a sign at a visible area indicating the maximum height or a horizontal bar hanged from the ceiling to guide the vehicle when they enter into the garage or the parking lot. However, a driver may sometimes is not aware of the height of his vehicle and decides to go forward even after the height indicators and ends up damaging the vehicle and/or the property. There is a need for a better management system for vehicles with above the permitted height in garage or parking lot.

### SUMMARY

The present disclosure relates to a vehicle height clearance system. More specifically, the disclosure relates to a vehicle height clearance system with a sensor, such that the sensor helps in indicating a driver of a vehicle that their vehicle is above the permitted height, as required to enter a garage or a parking lot.

In one embodiment, the system as disclosed comprise of a bar; a compartment; a high-intensity alarming light and an electronic sign board. In another embodiment, the system comprises more than one bar such as four bars and more than one compartment such as four compartments.

In one embodiment, the system comprises of a photo-sensor bar; an infrared emission bar and two alarming light bars. In another embodiment, the infrared emission bar may be installed at a required distance from a garage or a parking lot entrance gate. The distance will depend on how early a signal should reach the driver to let the driver know about vehicle height such that driver can decide to enter or not to enter the garage or parking lot and also there should be enough space for the vehicle to turn around. In yet another embodiment, the photo-sensor bar may be present at a distance of approximately 2.5 meters from the infrared emission bar, such that the photo-sensor bar and the infrared emission bar are present on opposite side of the garage or a parking lot entrance gate. However, the distance between the photo-sensor bar and the infrared emission bar may also depend on the distance of the entrance way to the garage or parking lot or other such area where the system may be installed.

In one embodiment, each of the four bars further comprise of a compartment. In another embodiment, the infrared emission bar further comprises of an infrared emission compartment and the photo-sensor bar comprise of a photo-sensor compartment. In yet another embodiment the infrared emission bar further comprise of an upper infrared emission compartment and a lower infrared emission compartment. Further, the photo-sensor bar comprise of an upper photo-sensor compartment and a lower photo-sensor compartment.

In one embodiment, the infrared emission compartment as attached to the infrared emission bar is a hollow cylindrical metallic body. In another embodiment, the infrared emission compartment may be of other shape such as a rectangle, square as referenced to the shape of the infrared emission bar. The cylindrical shape is open from one side and comprise of more than one wing, which forms an opening. The infrared emission compartment can further be adjusted, moved up or down and fixed onto the infrared emission bar. There is a hole present onto the wings of the infrared emission compartment, wherein a screw can pass through the hole and with the screw nut can help fix the infrared emission compartment at a desirable height onto the infrared emission bar. The infrared emission compartment further comprise of an infrared piece that emits an infrared signal towards the photo-sensor bar, wherein the photo-sensor bar is present on the same line of axis as of the infrared emission bar.

In one embodiment, the upper infrared emission compartment and lower infrared emission compartment are positioned such that the upper infrared emission compartment is at a position indicating the highest permissible vehicle height and the lower infrared emission compartment is at least 0.5 m away from the ground level.

In one embodiment, the photo-sensor compartment as attached to the photo-sensor bar is a hollow cylindrical metallic body. In another embodiment, the photo-sensor compartment may be of other shape such as a rectangle, square as referenced to the shape of the photo-sensor bar. The cylindrical shape is open from one side and comprise of more than one wing, which forms an opening. The photo-sensor compartment can further be adjusted, moved up or down and fixed onto the photo-sensor bar. A hole is present onto the wings of the photo-sensor compartment, wherein a screw can pass through the hole and with the screw nut can help fix the photo-sensor compartment at a desirable height onto the photo-sensor bar. The photo-sensor compartment further comprise of a photo-sensor piece. The photo-sensor piece and the infrared piece are position in such a way that they face each other and form's an invisible line, invisible to naked eye, when the system is in ON position.

In one embodiment, the upper photo-sensor compartment and lower photo-sensor compartment are positioned such that the upper photo-sensor compartment is at a position indicating the highest permissible vehicle height and the lower photo-sensor compartment is at least 0.5 m away from the ground level.

In one embodiment, the system comprises more than one alarming light bar such as two alarming light bars. In yet another embodiment, the alarming light bar is installed at a distance or approximately 0.5 meter away from the garage or the parking lot entrance gate. The distance may be more or less than the indicated and will depend on manufacturer or owner choice. The alarming light bars are present on either sides or one side of the entrance of the garage or parking lot. The alarming light gets activated if and when a vehicle with above the permissible height passes through the system such that it gives an indication to the driver to stop.

In one embodiment, an electronic sign is present on top of the garage or parking lot entrance gate whereas in another embodiment, the electronic sign may be present on a desired location such as the left side or the right side of the garage or parking lot entrance gate.

In one embodiment, the infrared emission bar and the photo-sensor bar are installed on either side of the entrance to the garage or the parking lot gate such that the infrared piece and the photo-sensor piece face each other. All the compartments and system is linked to an electronic source.

In one embodiment, an infrared signal being emitted from the infrared piece falls onto the photo-sensor piece present on the photo-sensor compartment and forms an infrared line. In another embodiment, an infrared signal being emitted from the infrared piece present on the upper infrared emission compartment falls onto the photo-sensor piece present on the upper photo-sensor compartment and forms an upper infrared line. In yet another embodiment, an infrared signal being emitted from the infrared piece present on the lower infrared emission compartment falls onto the photo-sensor piece present on the lower photo-sensor compartment and form a lower infrared line. Thus, the system when ON has the upper and lower infrared lines which are invisible to a naked eye.

Thus, in one embodiment, a vehicle height clearance sensor system is disclosed comprising: an infrared emission bar; a photo-sensor bar; an alarming light bar and an electronic sign, wherein the system indicates if a vehicle is above a permissible height and help a driver to decide whether to enter or not to enter the vehicle into a garage or a parking lot entrance gate. In another embodiment, the vehicle height clearance system further comprises: an upper infrared emission compartment and a lower infrared emission compartment fixed onto the infrared emission bar; an upper photo-sensor compartment and a lower photo-sensor compartment fixed onto the photo-sensor bar; and two high intensity alarming lights. In yet another embodiment, the system as disclosed comprises: an infrared piece present on the infrared emission compartment; and a photo-sensor piece present on the photo-sensor compartment, wherein infrared piece emits an infrared signal such that the infrared signal falls onto the photo-sensor piece to form a line invisible to a naked eye.

In one embodiment, a functioning of a vehicle height clearance system to clear a vehicle with permissible height to pass through a garage or a parking lot entrance gate is disclosed. The functioning as disclosed, comprises: switching ON the system, such that an infrared signal is emitted each from an upper infrared emission compartment and a lower infrared emission compartment, wherein the infrared emission compartment is present on an infrared emission bar; forming of two invisible infrared lines, wherein the lines are formed when the infrared signal from the infrared emission compartment falls onto a photo-sensor compartment present on a photo-sensor bar; passing of a vehicle through the system to enter into the garage or parking lot entrance gate, wherein as the vehicle passes the system, vehicle will cross the infrared lines; and moving of the vehicle into the garage or parking lot such that the vehicle crossed only a single infrared line indicating that the vehicle has a permissible height. In another embodiment, the functioning as disclosed further comprises: activation of an alarming light, wherein the activation indicates that the vehicle cross the two infrared lines; moving of the vehicle into the garage or parking lot such that the vehicle crossed both the infrared lines indicating that the vehicle does not have a permissible height and cannot pass through the garage or parking lot entrance gate. The system is established outside of a garage or a parking lot entrance gate. If the vehicle has a permissible height, vehicle will cross only the infrared signal emitted from the lower infrared emission compartment and can pass through the entrance. However, if the vehicle does not have a permissible height, vehicle will cross both the infrared signal emitted from the lower and upper infrared emission compartment and cannot pass through the entrance. The two infrared lines as formed are an upper infrared line and a lower infrared line.

In one embodiment, as the vehicle cross through the upper and lower infrared line, the garage entrance gate will start to close automatically, even if it started to open after receiving a signal from a garage remote as operated by a driver or another user. In another embodiment, the alarming light will also be activated, providing a strong signal to the driver of the vehicle, indicating the driver that the height of the vehicle is above the permissible height. In yet another embodiment, an electronic sign may also be present on the system, indicating a message to the driver that the vehicle is above the permissible height.

Thus, in most embodiments, as the vehicle pass through the entrance of the garage or the parking lot entrance gate, the vehicle will pass through the upper and lower infrared lines, wherein if the vehicle cross only the lower infrared lines and does not touch the upper infrared line, vehicle can pass through the entrance gate as compared to if the vehicle cross both the upper and the lower infrared lines. Further, crossing of both the upper and lower infrared lines triggers a chain of events or a single event such as closing of the garage or parking lot entrance gate; activation of the alarming light and display onto the electronic sign giving indicators to the driver that the vehicle is above the permissible height. All three events can happen in series or just one event following crossing of both the upper and lower infrared lines by the vehicle.

The system as disclosed depends on a photo-sensor and an infrared to detect the height of the vehicle. As soon as the vehicle crosses the lines, chain of events or a single event will occur in a time as fixed by the user of the system.

Other features will be apparent from the accompanying drawings and from the detailed description that follows.

### BRIEF DESCRIPTION OF DRAWINGS

Example embodiments are illustrated by way of example and not limitation in the figures of the accompanying drawings, in which like references indicate similar elements and in which:

FIG. 1 shows embodiments of disclosed vehicle height clearance sensor system.

FIG. 2 shows a top view of the disclosed vehicle height clearance sensor system.

FIG. 3 shows structural details of an infrared emission compartment.

FIG. 4 shows structural details of a photo-sensor compartment.

FIGS. 5A and 5B shows functioning of the disclosed vehicle height clearance sensor system.

FIG. 6 shows a step-by-step functioning of the disclosed system with a vehicle of a permissible height.

FIG. 7 shows a step-by-step functioning of the disclosed system with a vehicle above a permissible height.

Other features of the present embodiments will be apparent from the accompanying drawings and from the detailed description that follows.

### DETAILED DESCRIPTION

When a garage or parking lot is constructed for a residential or commercial building, they usually have a gate to give a permission to the eligible vehicle to enter. For example, when a driver enter the right numbers on the parking keypad or when the driver click on the garage remote, it gives them a permission to enter into the garage or parking lot. All the commercial or residential garage or parking lot have a height limitation whereby a vehicle with a particular height can be parked and does not allow vehicles with a height above those permissible limits. It is important to indicate a garage height limit because some large vehicle of a resident or a guest may have more height than the required and the driver of that vehicle is not aware of their vehicles' height. Further, as entering into the garage or parking lot, drivers are usually in hurry, they click on the remote or keypad and decided to enter without noticing the height sign, damaging their vehicles' ceiling and the garage/parking lot ceiling as well.

The usual way to deal with the vehicle height when entering the garage or parking lot depend mainly on a sign, or a horizontal bar, hanged from the ceiling to guide the vehicle as to the permissible height within that area. However, as mentioned the driver might not be aware of the actual height of his vehicle and decided to go forward and that lead to damages requiring repairs and thus cost.

The presented invention deals with the problem and provides a vehicle height clearance sensor system that can be installed and connected to a regular garage entrance door or a parking lot entrance door which do have height restrictions.

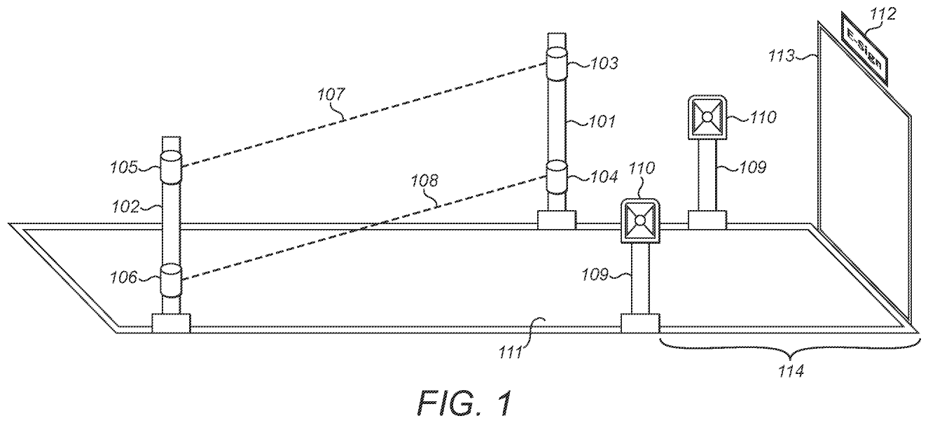

FIG. 1 shows details of the disclosed vehicle height clearance sensor system. As shown, the system comprises: a photo-sensor bar 101, an infrared emission bar 102, an alarming light bar 109 with an alarming light 110, an electronic display 112 and a garage or parking entrance gate 113. The photo-sensor bar 101 further comprises: an upper photo-sensor compartment 103 and a lower photo-sensor compartment 104. The infrared bar 102 further comprises of an upper infrared emission compartment 105 and a lower infrared emission compartment 106. The infrared emission bar and the photo-sensor bar are positioned on the sides of the entrance 111 to the garage or parking lot such that they face each other and are in line with each other or both the sides of the entrance. The upper infrared emission compartment and lower infrared emission compartment are positioned such that the upper infrared emission compartment is at a position indicating the highest permissible vehicle height and the lower infrared emission compartment is at least 0.5 m away from the ground level.

The infrared emission compartment emits an infrared signal such that an infrared signal is emitted from the upper infrared compartment 105 and another from the lower infrared emission compartment 106 forming an upper infrared line 107 and a lower infrared line 108 respectively. The system comprises two alarming light bars 109. The alarming light bar is installed at a distance or approximately 0.5 meter away from the garage or the parking lot entrance gate. The distance 114 may be more or less than the indicated and will depend on manufacturer or owner choice. The alarming light bars are present on both sides or one side of the entrance 111 of the garage or parking lot. The alarming light 110 gets activated if and when a vehicle with above the permissible height passes through the system such that it gives an indication to the driver to stop. The system further comprises of an electronic sign 112 present on top of the garage or parking lot entrance gate 113. The electronic sign may be present on a desired location such as the left side or the right side of the garage or parking lot entrance gate.

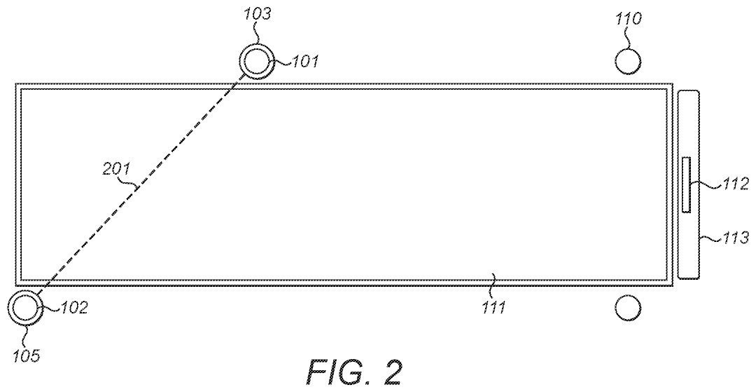

FIG. 2 shows a top view of the disclosed vehicle height clearance sensor system showing distance between the infrared emission bar 102 and the photo-sensor bar 101 is approximately 2.5 meter. However, distance can be more or less depending on the number of entrances to be covered e.g if there are more than one entrance gate to the garage or parking lot, infrared and photo-sensor bar can each be fixed onto one side of the garage/parking lot covering both the entrance. Also, distance may depend on the size of the vehicles such as vehicle is a car, truck, RV or others. Also, distance between the infrared bar and the alarming bar or distance between the photo-sensor bar and the alarming bar can vary depending on all the factors as stated above and also on the owner's or manufacturer's choice.

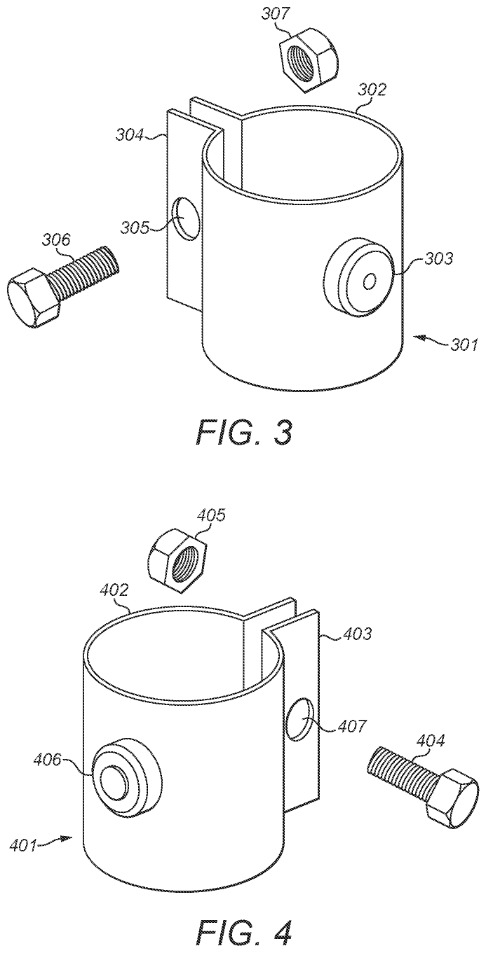

FIG. 3 shows structural details of an infrared emission compartment 301. As discussed above there is an upper infrared emission compartment 105 and lower infrared emission compartment 106. The position of upper infrared emission compartment is fixed such that it indicated the highest position for the vehicle or the permissible height. The lower infrared emission compartment is at least 0.5 meter away from the ground level.

The infrared emission compartment comprises a cylindrical body 302. The cylindrical shape is open from one side and comprise of more than one wing 304, which forms an opening. There is a hole 305 present onto the wings of the infrared emission compartment, wherein a screw 306 can pass through the hole and with the screw nut 307 can help fix the infrared emission compartment at a desirable height onto the infrared emission bar. The infrared emission compartment further comprise of an infrared piece 303 that emits an infrared signal towards the photo-sensor bar 101, wherein the photo-sensor bar is present on the same line of axis as of the infrared emission bar 102. The infrared emission compartment may be of other shape such as a rectangle, square as referenced to the shape of the infrared emission bar. The infrared emission compartment can further be adjusted, moved up or down and fixed onto the infrared emission bar.

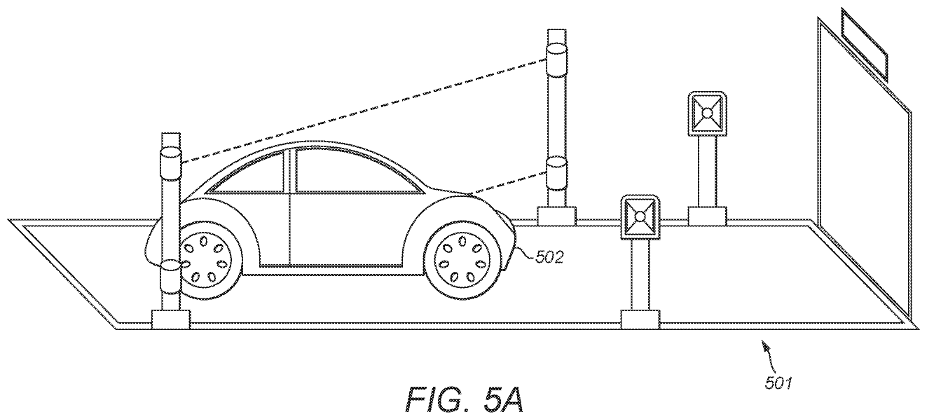

FIG. 4 shows structural details of an photo-sensor compartment 401. The photo-sensor compartment as attached to the photo-sensor bar 101 is a hollow cylindrical metallic body 402. The cylindrical shape is open from one side and comprise of more than one wing 403, which forms an opening. There is a hole 407 present onto the wings of the photo-sensor compartment, wherein a screw 404 can pass through the hole 407 and with the screw nut 405 can help fix the photo-sensor compartment at a desirable height onto the photo-sensor bar. The photo-sensor compartment further comprise of a photo-sensor piece 406. The photo-sensor piece and the infrared piece are position in such a way that they face each other and forms an invisible line, invisible to naked eye, when the system is in ON position. The photo-sensor compartment may be of other shape such as a rectangle, square as referenced to the shape of the photo-sensor bar. The photo-sensor compartment can further be adjusted, moved up or down and fixed onto the photo-sensor bar.

As discussed above there is an upper photo-sensor compartment 103 and lower photo-sensor compartment 104. The position of upper photo-sensor compartment is fixed such that it indicated the highest position for the vehicle or the permissible height. The lower photo-sensor compartment is at least 0.5 meter away from the ground level.

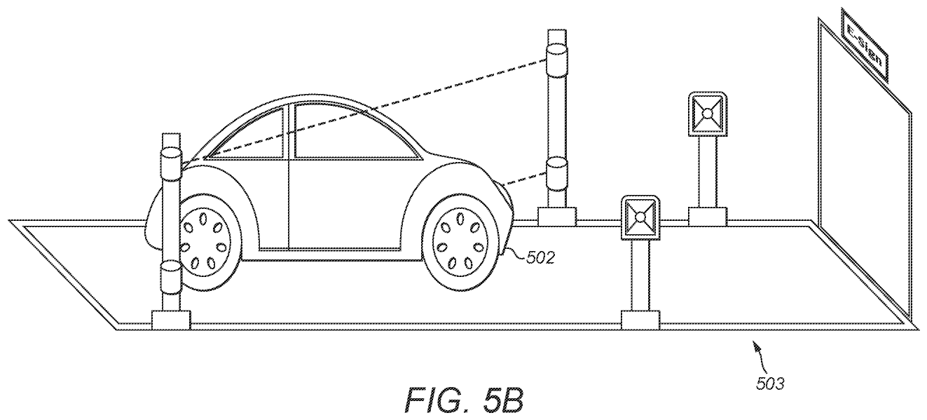

FIG. 5A shows a use of the disclosed system 501 as a vehicle 502 passes through the system. As shown, the system is showing to emit the upper infrared line 107 and the lower infrared line 108 from the infrared compartments. As the vehicle passes through the entrance 111 and thus through the system, it will cross the infrared lines. If the vehicle crosses only the lower infrared line 108, the vehicle is within the permissible height and thus the vehicle will pass through the garage or parking entrance gate. Further, as shown in FIG. 5B, if the vehicle crosses both the upper infrared line 107 and the lower infrared line 108, this gives an indication that the vehicle is above the permissible height and thus is not allowed to or should not enter the garage/parking gate 503. In such an event, as the vehicle crosses the upper infrared line, a chain of events or an event will occur giving indication to the driver or other that the vehicle is above the permissible height allowed to enter the garage/parking lot. The events that may occur is activation of one or more than one alarming lights 110 present on the alarming light bar 109. The alarming light is present in a visible range of the driver. Further, the garage entrance gate 113 will start to close automatically, even if it started to open after receiving a signal from a garage remote as operated by a driver or another user or entrance gate will not open even after the user gives signal through a garage/parking opener or entering keys on a keypad. A third event that may occur is that a message will be displayed onto the electronic sign 112 for driver to read that the vehicle is above the permissible height. The events can happen in a series such as crossing of both the infrared lines; activation of alarming lights; closing of the garage/parking gate, if it was signaled to open and displaying of a warning message on electronic sign board present in the visible and readable distance. Thus, the activation of alarming lights, closing of the garage/parking gate, and displaying of a warning message on electronic sign board can happen one after another as soon as the vehicle crosses both the infrared lines. The series can be changed or there can be just one event happening following crossing of both the lines such as closing or not opening of the garage or parking lot entrance gate; activation of the alarming light giving signal to stop the vehicle and display onto the electronic sign giving indicators to the driver that the vehicle is above the permissible height.

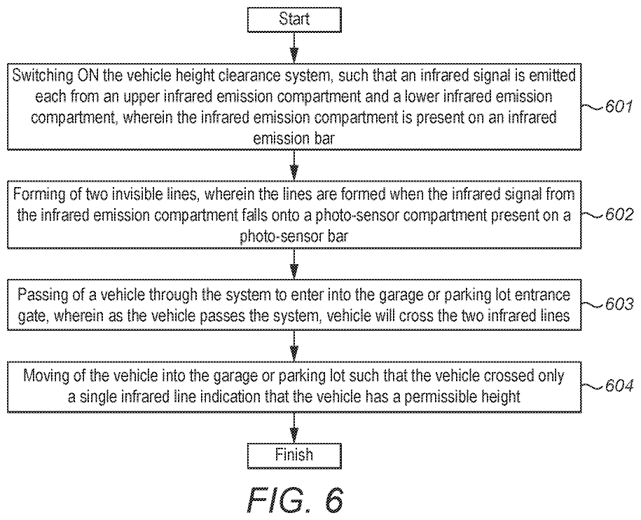

FIG. 6 shows a step-by-step functioning of the disclosed system with a vehicle of a permissible height. The functioning as disclosed comprises: switching ON the vehicle height clearance system, such that an infrared signal is emitted each from an upper infrared emission compartment and a lower infrared emission compartment, wherein the infrared emission compartment is present on an infrared emission bar 601; forming of two infrared lines, wherein the lines are formed when the infrared signal from the infrared emission compartment falls onto a photo-sensor compartment present on a photo-sensor bar 602; passing of a vehicle through the system to enter into the garage or parking lot entrance gate, wherein as the vehicle passes the system, vehicle will cross the two infrared lines 603; moving of the vehicle into the garage or parking lot such that the vehicle crossed only a single infrared line indicating that the vehicle has a permissible height 604.

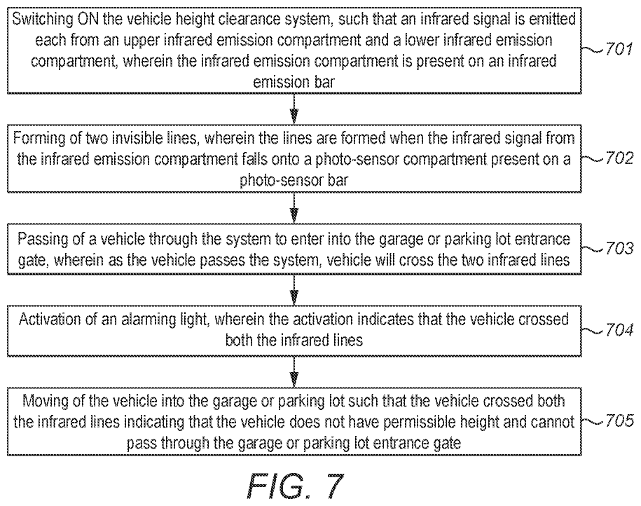

FIG. 7 shows a step-by-step functioning of the disclosed system with a vehicle above a permissible height. The functioning as disclosed comprises: switching ON the vehicle height clearance system, such that an infrared signal is emitted each from an upper infrared emission compartment and a lower infrared emission compartment, wherein the infrared emission compartment is present on an infrared emission bar 701; forming of two invisible lines, wherein the lines are formed when the infrared signal from the infrared emission compartment falls onto a photo-sensor compartment present on a photo-sensor bar 702; passing of a vehicle through the system to enter into the garage or parking lot entrance gate, wherein as the vehicle passes the system, vehicle will cross the two infrared lines 703; activation of an alarming light, wherein the activation indicates that the vehicle crossed both the infrared lines 704; moving of the vehicle into the garage or parking lot such that the vehicle crossed both the infrared lines indicating that the vehicle does not have a permissible height and cannot pass through the garage or parking lot entrance gate 705.

This is total electronic system, that does not require human intervention. The system depend on photo-sensors and infrared to detect the vehicle upper height. It prevent the vehicle from the entering the garage or parking automatically by closing the garage gate and giving the driver a warning and electronic explanation. Using two infrared lines help to differentiate in fraction of seconds between a vehicle with acceptable and unacceptable height.

Although the present embodiments have been described with reference to specific example embodiments, it will be evident that various modifications and changes may be made to these embodiments without departing from the broader spirit and scope of the various embodiments. Accordingly, the specification and drawings are to be regarded in an illustrative rather than a restrictive sense.

What is claimed is:

1. A vehicle height clearance sensor system, comprising:
an infrared emission bar;
a photo-sensor bar;
an alarming light bar; and
an electronic sign, wherein the system indicates if a vehicle is above a permissible height and help a driver to decide whether to enter or not to enter the vehicle into a garage or a parking lot entrance gate.

2. The vehicle height clearance sensor system of claim 1, wherein the infrared emission bar further comprises an upper infrared emission compartment and a lower infrared emission compartment fixed onto the infrared emission bar.

3. The vehicle height clearance sensor system of claim 1, wherein the photo-sensor bar further comprises an upper photo-sensor compartment and a lower photo-sensor compartment fixed onto the photo-sensor bar.

4. The vehicle height clearance sensor system of claim 2, wherein the upper and lower infrared emission compartment comprises an infrared piece such that the infrared piece emits an infrared signal.

5. The vehicle height clearance sensor system of claim 3, wherein the upper and lower photo-sensor compartment comprises a photo-sensor piece.

6. The vehicle height clearance sensor system of claim 1, wherein the alarming light bar comprises an alarming light.

7. The vehicle height clearance sensor system of claim 1, wherein the alarming light bar is installed at a distance of 0.5 meter away from the garage or the parking lot entrance gate.

8. The vehicle height clearance sensor system of claim 2, wherein the upper infrared emission compartment is fixed at a position indicating the highest permissible vehicle height for the garage or a parking lot entrance gate.

9. The vehicle height clearance sensor system of claim 2, wherein the lower infrared emission compartment is 0.5 meter away from the ground level.

10. The vehicle height clearance sensor system of claim 1, wherein the photo-sensor bar is at a distance of 2.5 meters from the infrared emission bar, such that the photo-sensor bar and the infrared emission bar are present on opposite side of the garage or a parking lot entrance gate.

11. The vehicle height clearance sensor system of claim 4, wherein an infrared signal is emitted from the infrared piece and falls onto the photo-sensor piece present on the photo-sensor compartment to form an infrared line.

12. The vehicle height clearance sensor system of claim 11, wherein an infrared signal is emitted from the infrared piece present on the upper infrared emission compartment and falls onto the photo-sensor piece present on the upper photo-sensor compartment to form an upper infrared line.

13. The vehicle height clearance sensor system of claim 11, wherein an infrared signal is emitted from the infrared piece present on the lower infrared emission compartment and falls onto the photo-sensor piece present on the lower photo-sensor compartment to form a lower infrared line.

14. A functioning of a vehicle height clearance sensor system to clear a vehicle with permissible height to pass through a garage or a parking lot entrance gate, comprising:
switching ON the system, such that an infrared signal is emitted each from an upper infrared emission compartment and a lower infrared emission compartment, wherein the infrared emission compartment is present on an infrared emission bar;
forming of two infrared lines, wherein the lines are formed when the infrared signal from the infrared emission compartment falls onto a photo-sensor compartment present on a photo-sensor bar;
passing of the vehicle through the system to enter into the garage or parking lot entrance gate, wherein as the vehicle passes the system, vehicle will cross the infrared lines; and
moving of the vehicle into the garage or parking lot such that the vehicle crossed only a single infrared line indicating that the vehicle has a permissible height.

15. The functioning as in claim 14, wherein the functioning further comprises:
activation of an alarming light;
closing or not opening of the garage or parking lot entrance gate; and
displaying of a message onto an electronic sign thereby indicating that the vehicle crossed both the infrared lines and so does not have a permissible height, wherein the vehicle cannot pass through the garage or parking lot entrance gate.

16. The functioning as in claim 14, wherein the photo-sensor bar may be present at a distance of 2.5 meters from the infrared emission bar, such that the photo-sensor bar and the infrared emission bar each are present on opposite side of the garage or a parking lot entrance gate.

17. The functioning as in claim 14, wherein the alarming light is present on an alarming light bar such that the bar is installed at a distance of 0.5 meter away from the garage or the parking lot entrance gate and gives a warning sign to stop the vehicle.

18. The functioning as in claim 15, wherein activation of alarming lights, closing of the garage or parking gate, and displaying of a warning message on electronic sign can happen one after another as soon as the vehicle crosses both the infrared lines.

19. The functioning as in claim 14, wherein the upper infrared emission compartment is positioned at a position indicating the highest permissible vehicle height for the garage or a parking lot entrance gate.

20. The functioning as in claim 14, wherein the system helps in differentiating between a vehicle with acceptable and unacceptable height.
